(19) United States
(12) Patent Application Publication
(10) Pub. No.: US 2006/0229942 A1
(43) Pub. Date: Oct. 12, 2006

(54) Method and automated system for creating and tracking on-line embedded search event records and generating leads

(76) Inventors: Michael R. Miller, Pompano Beach, FL (US); Gregory P. Miller, Parkland, FL (US)

Correspondence Address: JONES, TULLAR & COOPER, P.C., P.O. BOX 2266 EADS STATION, ARLINGTON, VA, 22202, US

(21) Appl. No.: 11/401,420

(22) Filed: Apr. 11, 2006

Related U.S. Application Data
(60) Provisional application No. 60/669,899, filed on Apr. 11, 2005.

(51) Int. Cl. G06Q 30/00

(52) U.S. Cl. 705/14

(57) ABSTRACT

A method for gathering and reporting lead generation data for use when evaluating contextual ads in e-commerce and elsewhere includes real-time generation of prospect data in a single report or Embedded Search Event Record including: Identification of the specific advertisement campaign; Identification of the actual advertisement; Identification of the keyword or keyword combinations the visitor used to find the ad; Identification of the place where the advertisement was seen when the visitor self selected or “clicked”; Identification of the actual destination page the visitor was delivered to; Identification of any promotional offers redeemed by the visitor when they self selected and became a “lead”; Identification of the cost to generate the lead; Identification of the advertising company running the campaign; Identification of the position the ad was in when it was clicked; and Identification of the cost of the “click”.

### RELATED APPLICATION INFORMATION

This application claims priority to co-pending provisional application No. 60/669,899, filed Apr. 11 th, 2005, the entire disclosure of which is incorporated herein by reference.

### BACKGROUND OF THE INVENTION

1. Field of the Invention

The present invention relates to on-line electronic marketing and specifically to search engine based contextual advertising for lead generation or customer prospecting.

2. Discussion of the Prior Art

With the advent of internet advertising and specifically search engine advertising, contextual advertising has become very popular. Web search providers such as Yahoo™ and Google™ offer advertising services of this type.

A contextual ad system scans the text of a Web site for keywords and returns ads to the Web page based on what the user is viewing, either through ads placed on the page or pop-up ads. For example, if the user is viewing a site about sports, and the site uses contextual advertising, the user might see ads for sports-related companies, such as memorabilia dealers or ticket sellers.

Contextual advertising is also used by search engines to display ads on their search results page, and ad selection is based on the words or phrases included in a user's search. Advertisers create ads that link to specific sets of key words with the intention of relating these ads to a specific target audience.

Advertisers are encouraged to bid against other advertisers desiring similar keywords to secure positioning for these advertisements to be displayed. Advertisers are then commonly charged the bid amount when an ad is “clicked”. From that point, it is assumed that the person clicking on the ad is delivered to the advertiser's website.

From the advertisers' point of view, the value received is a stream of targeted visitors to their website. The hope is that these visitors will turn into customers or initiate communication with the advertiser.

Most visitors are directed into the home pages of the customer's website, however some advertisers direct traffic into other areas such as: e-commerce components, communication forms or other specific areas in an effort to maximize the advertisers' marketing performance.

The methods of creating and uploading contextual ads into these search engines and advertising places are proprietary to each search engine operator (e.g., Yahoo™ or Google™ search engine operators) and so vary accordingly. The lack of a single well-defined and understood method of managing the contextual ad-creating and uploading process creates a level of frustration and difficulty for the advertiser. This disparity between search engine operator/advertising companies and their technologies prevent an easy to implement and use system for creating ads, assigning keywords, selecting audiences, measuring performance, and tracking the many components relating to this form of advertising.

To make advertising using these methods more difficult, ads are usually created online using HTTP-based web forms, forcing the ads to be created in a technical environment as opposed to a “creative” environment. The prior art HTTP-based method forces the advertiser to write a headline first, followed by body copy, and then identify the audience with key words. With actual advertising space being very limited, (usually less than 100 characters) creating effective ads is very challenging in the best environments. In addition, this approach has proven to be clumsy for advertising professionals, since the “Best Practices” approach to advertising is to first identify the audience, select key words and then develop the advertisement to address that audience.

When lead generation is the goal of the advertisement, knowing why and how the lead was generated becomes important. Lead generation data, if available, enables an advertiser to understand conditions and components used by a given web site visitor (or lead) when generating the lead. Knowing such information enables the advertiser to replicate that success and begin to maximize their return on investment. In addition, it is important for the sales person receiving the lead to know exactly what the web site visitor (or prospect) responded to.

Currently this lead generation data is not readily available, and the measurement of specific components relating to these advertising methods is a complicated process involving technical know-how, access to web server data, (which is usually not available for access) sophisticated log analysis software, and the integration of information from many disparate data sources, both internally and with the advertising companies.

To further complicate matters, each service provider (i.e., each search engine or contextual advertising media service provider) has its own proprietary method of reporting the performance of their networks and ads.

In all cases, the data collected is not easily assembled nor conveniently revealed to indicate the actual conditions of keywords, ad copy, placement, audience, etc., when a specific advertisement was clicked and the visitor made a choice to become a lead.

Many advertisers run multiple electronic advertisements, in multiple places, with multiple offers, and extensive keyword combinations. Understanding the performance of these campaigns can make a significant difference in the advertiser's Return on Investment (ROI).

There is a need, therefore, for an effective way to gather and report lead generation data for use when evaluating contextual ads in e-commerce and elsewhere.

### SUMMARY OF THE INVENTION

Accordingly, it is an object of the present invention to overcome the above mentioned difficulties by providing an effective way to gather and report lead generation data for use when evaluating contextual ads in e-commerce and elsewhere.

Another object of the present invention is using contextual advertising to display ads to targeted audiences (e.g., in connection with web search providers such as MSN™, Yahoo™ or Google™) while providing advertisers tools for monitoring, measuring and, when necessary, changing advertisement components in real time to maximize the effectiveness of contextual advertising.

The aforesaid objects are achieved individually and in combination, and it is not intended that the present invention be construed as requiring two or more of the objects to be combined.

The method and system of the present invention captures, records and tracks unique search episode data occurring during a users' “search event” when the search episode results in a “click” or “conversion”. The system delivers the search episode data to the advertiser in aggregated reports but, more importantly, within the “lead” in order for the advertiser to understand more details about the mindset of the user or searcher and to identify and correlate behavior patterns of multiple users with various success outcomes (conversions, purchases, etc.)

The method and software engine of the present invention identifies data components within the body copy of the actual lead, as the lead report is generated. The data generated by the engine puts the market condition data inside a lead report and so no additional reporting tools, software, data integration, or technical know-how is necessary to access and understand this information.

The method of the present invention provides a system for generating and inserting the marketing data at the time of the “click”, therefore capturing this information and placing the data inside the lead or to another user-defined document. “Click” as used here, means an action by a prospective customer such as a selection using a mouse or other pointing device when selecting, for example, a hypertext link in a web page or the like (e.g., when using a web search provider such as MSN™, Yahoo™ or Google™).

Lead reports generated using this invention contain the following condition information:

(1) Identification of the specific advertisement campaign;

(2) Identification of the actual advertisement;

(3) Identification of the keyword or keyword combinations the visitor or prospect used to find the web-based ad (e.g., when using a web search tool such as MSN™, Yahoo™ or Google™);

(4) Identification of the place or URL where the advertisement was seen when “clicked”;

(5) Identification of the actual destination page the visitor was delivered to;

(6) Identification of any promotional offers redeemed by the visitor when they self selected and became a “lead”;

(7) Identification of the cost to generate the lead;

(8) Identification of the advertising company running the campaign;

(9) Identification of the position the ad was in when it was clicked; and

(10) Identification of the cost of the visitor's self selection or “click”.

Another advantage of the method of the present invention is how advertisers use the data generated to actually create new advertising campaigns and upload them into the service providers' (e.g., MSN/Google/Yahoo) inventories. Users build their advertising campaigns in an environment conducive to creating effective advertisements.

An easy-to-use campaign builder method begins with identifying the audience, and suggests advertising copy to enable an effective and coercive communication with the audience.

In accordance with the present invention, input screens are designed to guide the user through the process of creating these ads for the different advertising agencies. Users simply select the service provider from an input screen, and the rules associated with that service provider are enabled as a user creates each campaign. Rules like character limitations, advertising text guidelines, and keyword selecting/matching come into effect.

In addition to creating the ads, the tool allows for entering and managing keyword bids, and bulk uploading these ads into the selected service provider's inventory.

Completed ads contain unique set of URLs for each contextual ad created. The unique URLs open a dynamic (created on the fly) destination page matching the advertisement, and identify the campaign components. These unique URL's will generate a specific, dynamic lead-capture page related to the campaign and to the keywords and environment used to find the ad campaign.

### Exemplary Embodiment of the Method

A specific lead capture page is dynamically created from the advertising engine of the present invention based on the unique URL of the clicked-on advertisement. This capture web page, when used with the unique URL, generates an identification element that is processed and forward with the collected lead data. This data is then decoded with the invention system to display the campaign details described above, and written into the body copy of the lead itself. In the example of an on-line banner advertisement, the destination URL is created using the same method, and the engine generates a specific URL matched to that advertising campaign.

When a lead is produced, the source of that lead, (in this case a very specific banner advertisement) is revealed inside the body of the actual lead. Next, a specific advertisement can yield a specific lead, and the source of that lead, or the success of that banner is immediately recognized, without other software or analysis necessary.

The invention enables identification of the prospect's search conditions, source of the audience; specific keyword combinations searched, and exact content of the advertisement responsible for generating the lead. This information is useful in responding to the lead, since the prospect's motivations and interests are identified in the lead contents. In addition, the system allows for multiple types leads to be running simultaneously without confusion, since the leads produced with the system clearly identify the advertisement and so permit identification of what the prospect is responding to.

In addition, the method of the invention provides a method of easily producing, managing, and submitting contextual ads to different service providers' advertising places. After ads are submitted, the invention provides the capability of tracking the performance of each ad in real time, without requiring any additional software or technical know how.

Furthermore, the invention provides for the leads generated using the system to contain the prospect's characteristics and interests inside the content of the lead itself to help better understand the desires of the prospect. In addition, a copy of the advertisement is displayed inside the lead report.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a schematic diagram illustrating the method of the present invention, showing steps a user executes when creating a contextual advertisement campaign.

FIG. 2 illustrates the method steps executed when a prospect clicks on an advertisement, in accordance with the present invention.

FIG. 3 illustrates another embodiment of the method, in accordance with the present invention.

FIG. 4 illustrates another embodiment of the method, in accordance with the present invention.

### DESCRIPTION OF THE PREFERRED EMBODIMENT

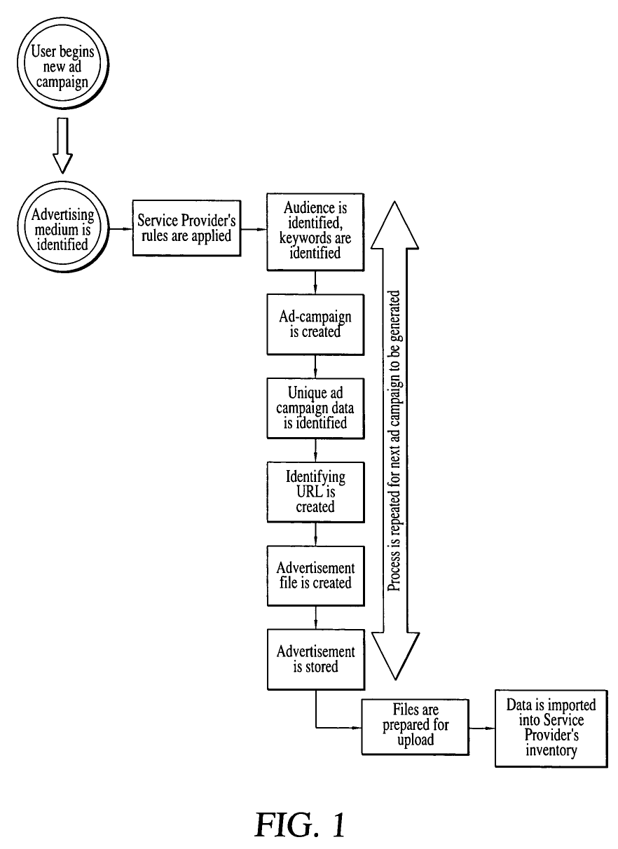

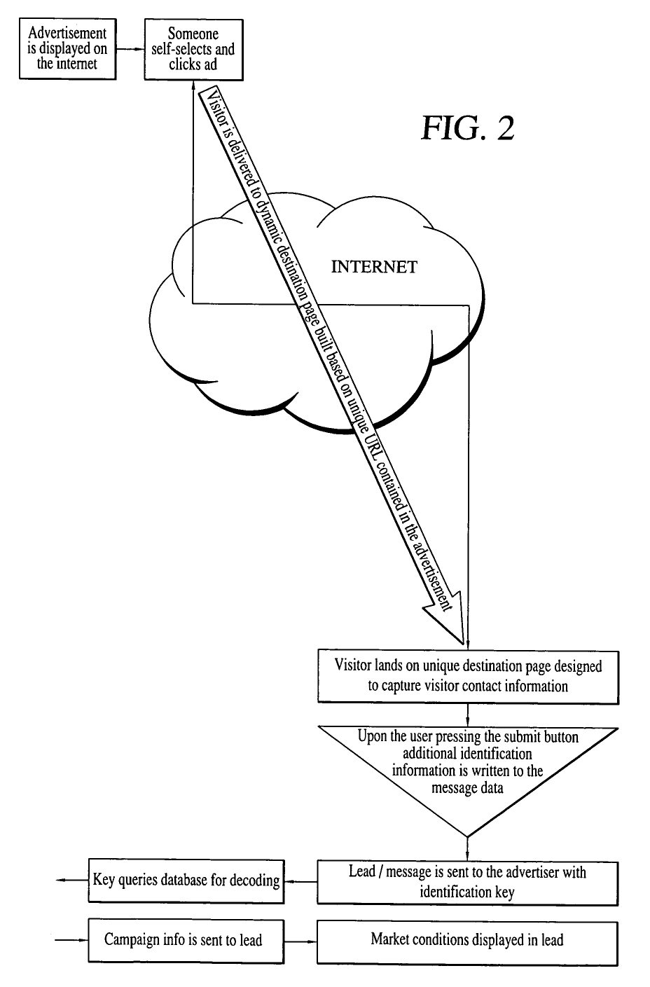

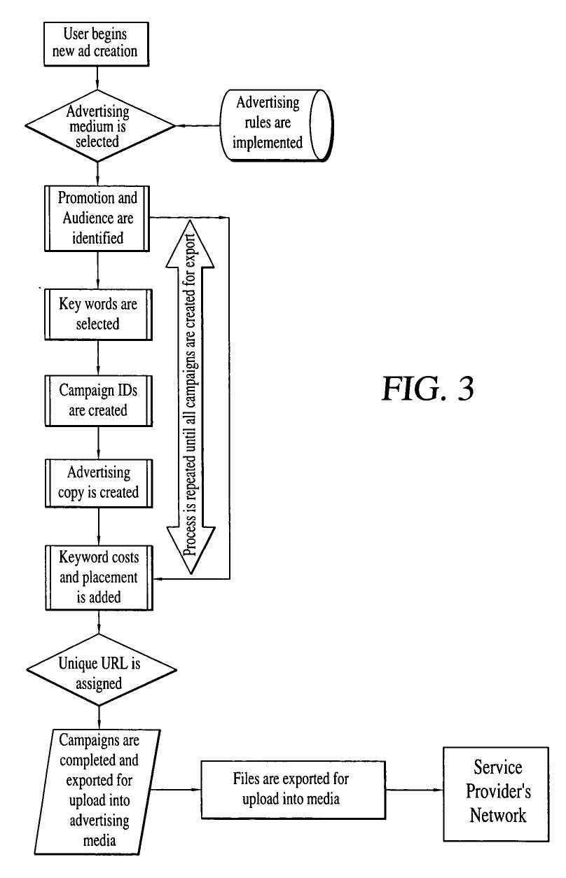

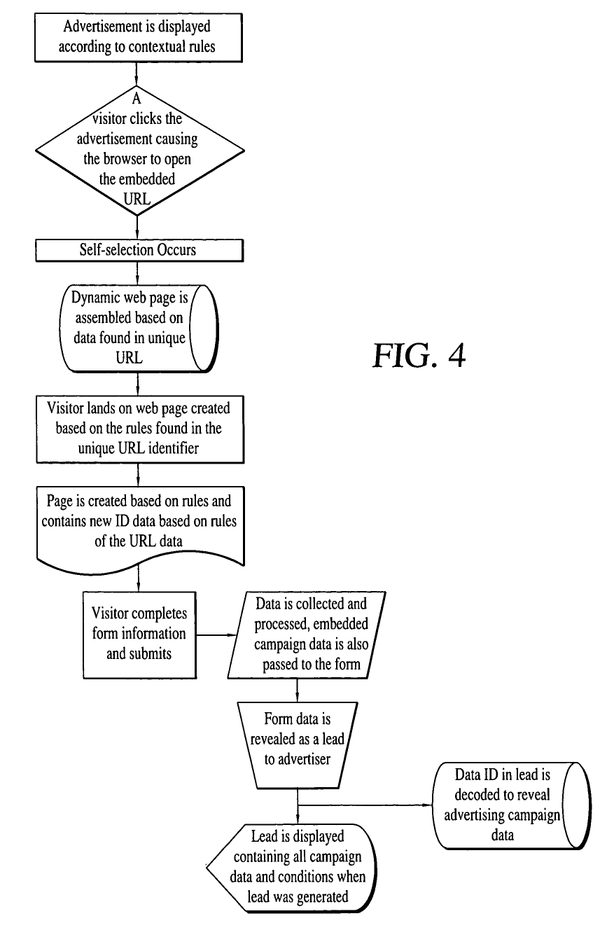

Referring to FIGS. 1-4, a more natural method of creating contextual advertisements uses a rules based approach incorporating the service provider's rules to guide the user in creating ads to run in selected networks.

The method and software engine of the present invention identifies data components within the body copy of the actual lead, as the lead report is generated. The data generated by the engine puts the market condition data inside the lead itself and so no additional reporting tools, software, data integration, or technical know-how is necessary to access and understand this information.

The method of the present invention provides a system for generating and inserting the marketing data at the time the visitor self-selects or generates a “click”, therefore capturing this information and placing the data inside a lead report or another user-defined document. “Click” as used here, means an action such as a self selection by a visitor or prospective customer using a mouse or other pointing device when selecting, for example, a hypertext link in a web page or the like.

Lead reports generated using this invention contain the following condition information: Identification of the specific advertisement campaign; Identification of the actual advertisement; Identification of the keyword or keyword combinations the visitor used to find the ad; Identification of the place where the advertisement was seen when the visitor self selected or “clicked”; Identification of the actual destination page the visitor was delivered to; Identification of any promotional offers redeemed by the visitor when they self selected and became a “lead”; Identification of the cost to generate the lead; Identification of the advertising company running the campaign; Identification of the position the ad was in when it was clicked; and Identification of the cost of the “click”.

Another advantage of the method of the present invention is how advertisers use the data generated to actually create new advertising campaigns and upload them into the service provider's inventories. Users build their advertising campaigns in an environment conducive to creating effective advertisements.

An easy-to-use campaign builder method begins with identifying the audience, and suggests advertising copy to enable an effective and coercive communication with the audience.

In accordance with the present invention, input screens are designed to guide the user through the process of creating these ads for the different advertising agencies. Users simply select the service provider from an input screen, and the rules associated with that service provider are enabled as a user creates each campaign. Rules like character limitations, advertising text guidelines, and keyword selecting/matching come into effect.

In addition to creating the ads, the tool allows for entering and managing keyword bids, and bulk uploading these ads into the service provider inventory. Completed ads contain unique set of URLs for each contextual ad created. The unique URLs open a dynamic (created on the fly) destination page matching the advertisement, and identify the campaign components. These unique URL's will generate a specific, dynamic lead-capture page related to the campaign and to the keywords and environment used to find the ad campaign.

### Exemplary Embodiment of the Method

A specific lead capture page is dynamically created from the advertising engine of the present invention based on the unique URL of the clicked-on advertisement. This capture web page, when used with the unique URL, generates an identification element that is processed and forward with the collected lead data. This data is then decoded with the invention system to display the campaign details described above, and written into the body copy of the lead itself. In the example of an on-line banner advertisement, the destination URL is created using the same method, and the engine generates a specific URL matched to that advertising campaign.

When a lead is produced, the source of that lead, (in this case a very specific banner advertisement) is revealed inside the body of the lead report. Next, a specific advertisement can yield a specific lead, and the source of that lead, or the success of that banner is immediately recognized, without other software or analysis necessary.

The invention enables identification of the prospect's search conditions, source of the audience; specific keyword combinations searched, and exact content of the advertisement responsible for generating the lead. This information is useful in responding to the lead, since the prospect's motivations and interests are identified in the lead contents. In addition, the system allows for multiple types leads to be running simultaneously without confusion, since the leads produced with the system clearly identify the advertisement and so permit identification of what the prospect is responding to.

In addition, the method of the invention provides a method of easily producing, managing, and submitting contextual ads to different service providers. After ads are submitted, the invention provides the capability of tracking the performance of each ad in real time, without requiring any additional software or technical know-how.

Furthermore, the invention provides for the leads generated using the system to contain the prospect's characteristics and interests inside the content of the lead itself to help better understand the desires of the prospect. In addition, a copy of the advertisement is displayed inside the lead report.

An automated method for creating multiple contextual advertisements uses key word combinations for automated inclusion into service provider's inventories. The method is used to generate contextual advertisements where the user can approach the creation from a more natural process, with coaching supplied from a database of advertising help suggestions.

In a preferred embodiment, the method includes tracking the performance of multiple conditions of contextual advertisements running on one or more service provider networks. The method also includes identifying the specific marketing conditions occurring when a contextual advertisement is selected or “clicked” by a visitor or prospect, and preferably identifies all of the above-mentioned conditions in a report having a format defined by the contents of a submitted form.

The actual advertisement responsible for generating the lead is identified as part of the report generated on the lead, and that report, or current lead profile, also displays the advertising art the prospect responded to.

The collected form data is segregated or split into different channels, so market data can be sent to a marketing person, and the advertising offer or promotional data can be sent to the sales channel personnel, along with the customer data. This ability enables data collected to be channeled to personnel related to that information, and enables protecting sensitive data and sending only selected lead data where it is desired to go.

It will be appreciated by those of skill in the art of e-commerce programming that the report generation system and information gathering/recording method of the present invention makes a number of things available, including:
A better more natural method of creating contextual advertisements using a rules-based approach that uses the advertising companies' rules to guide the user in creating ads to run in selected networks.
An automated method of creating multiple contextual advertisements with key word combinations for automated inclusion into advertising companies inventories.
A method of generating contextual advertisements where the user can approach the creation from a more natural process, with coaching supplied from a database of advertising help suggestions.
A method for tracking the performance of multiple conditions of contextual advertisements running on one or more advertising networks (advertising companies).
A method of identifying the specific marketing conditions occurring when a contextual advertisement is clicked.
A method of identifying the above conditions inside the contents of a submitted form.
A method of identifying the actual advertisement responsible for generating the lead, from within the lead itself.
A method of displaying the advertising art the current lead profile responded to.
A method of splitting collected form data into different channels, whereas market data can be sent to a marketing person, and the advertising offer or promotional data can be sent to the sales channel along with the customer data. This ability enables data collected to be channeled to personnel related to that information, and enables protecting sensitive data and sending only selected lead data where it is desired to go.
A method of being able to recreate the experience the searcher had when he became the lead.
A method of identifying where to run advertisements for the highest conversions.
A method if identifying negative keywords in search words so advertisers can ensure their ads are delivered to the most targeted audiences.

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention as set forth in the claims.

What is claimed is:

1. A method for creating contextual advertisements using a rules-based approach incorporating service provider's rules to guide a user in creating advertisements to run in selected networks, comprising:
(a) gathering a first service provider's rules for on-line advertisements;
(b) gathering a second first service provider's rules for on-line advertisements;
(c) incorporating said first service provider's rules and said second service provider's rules into a software program adapted to guide the user in creating advertisements to run in selected networks potentially including at least said first and second service provider;
(d) recording lead generation data for use when evaluating contextual ads in e-commerce;
(e) generating, in real time, an embedded search event record on prospect data in a single report including: Identification of the specific advertisement campaign; Identification of the actual advertisement; Identification of the keyword or keyword combinations the visitor used to find the ad; and
(f) evaluating said embedded search event record to determine return on investment for said contextual ads.

2. The method for creating contextual advertisements of claim 1, wherein step (e) further comprises:
(e2) generating, in real time, within said embedded search event record on prospect data in a report including: Identification of the place where the advertisement was seen when the visitor self selected or “clicked”; Identification of the actual destination page the visitor was delivered to; Identification of any promotional offers redeemed by the visitor when they self selected and became a “lead”; Identification of the cost to generate the lead; Identification of the advertising company running the campaign; and Identification of the position the ad was in when it was clicked; and Identification of the cost of the “click”.

3. An automated method of creating multiple contextual advertisements with key word combinations for automated inclusion into service provider inventories, comprising:
(a) gathering a first service provider's rules for on-line advertisements;
(b) gathering a second first service provider's rules for on-line advertisements;
(c) incorporating said first service provider's rules and said second service provider's rules into a software program adapted to guide the user in creating advertisements to run in selected networks potentially including at least said first and second service provider;
(d) providing, as part of said software program, an automated record generation mechanism for gathering lead generation data to be used when evaluating contextual ads in e-commerce;
(e) providing, as part of said software program, an automated record generation mechanism for recording, in real time, prospect data for inclusion in a single report including: Identification of the specific advertisement campaign; Identification of the actual advertisement; Identification of the keyword or keyword combinations the visitor used to find the ad; Identification of the place where the advertisement was seen when the visitor self selected or “clicked”; Identification of the actual destination page the visitor was delivered to; Identification of any promotional offers redeemed by the visitor when they self selected and became a “lead”; Identification of the cost to generate the lead; Identification of the advertising company running the campaign; and Identification of the position the ad was in when it was clicked; and Identification of the cost of the “click”.

4. A method of generating contextual advertisements, with context sensitive help or coaching supplied from a database of advertising help suggestions, comprising:
(a) gathering a first service provider's rules for on-line advertisements;
(b) gathering a second first service provider's rules for on-line advertisements;
(c) incorporating said first service provider's rules and said second service provider's rules into a software program adapted to guide the user in creating advertisements to run in selected networks potentially including at least said first and second service provider;
(d) providing, as part of said software program, an automated record generation mechanism for gathering lead generation data to be used when evaluating contextual ads in e-commerce;
(e) providing, as part of said software program, an automated record generation mechanism for real time generation of an embedded search event record on prospect data in a single report including: Identification of the specific advertisement campaign; Identification of the actual advertisement; Identification of the keyword or keyword combinations the visitor used to find the ad;
(f) evaluating said embedded search event record to determine return on investment for said contextual ads; and
(g) populating a database with recommendations for the user relating to said evaluation and said return on investment for said contextual ads, wherein said recommendations are stored in a format adapted for use in context sensitive help or coaching for the user.

5. The method for creating contextual advertisements of claim 4, wherein step (e) further comprises:
(e2) providing, as part of said software program, an automated record generation mechanism for real time generation of an embedded search event record on prospect data in said single report including: Identification of the place where the advertisement was seen when the visitor self selected or “clicked”; Identification of the actual destination page the visitor was delivered to; Identification of any promotional offers redeemed by the visitor when they self selected and became a “lead”; Identification of the cost to generate the lead; Identification of the advertising company running the campaign; and Identification of the position the ad was in when it was clicked; and Identification of the cost of the “click”.
